(19) United States
(12) Patent Application Publication
(10) Pub. No.: US 2012/0163674 A1
(43) Pub. Date: Jun. 28, 2012

(54) MOTION DETECTION MODULE, ELECTRONIC DEVICE APPLYING THE MOTION DETECTION MODULE, AND MOTION DETECTION METHOD

(75) Inventors: PING-YANG CHUANG, Tu-Cheng (TW); YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/158,452

(22) Filed: Jun. 12, 2011

(30) Foreign Application Priority Data
Dec. 24, 2010 (TW) 99145677

(51) Int. Cl. G06K 9/00

(52) U.S. Cl. 382/107

(57) ABSTRACT

An electronic device which includes a motion detection module, a storage unit, and a processing unit. The motion detection module includes a heat detection unit, a recognition unit, and a processing unit. The heat detection unit is used to produce a series of detection signals in series when a human presence is detected around the electronic device within a predetermined area. The analysis unit is used to convert the detection signals into a series of binary images. The recognition unit compares the binary images sequentially and determines any change between these binary images, and is further able to determine the particular human motion which is taking place. The storage unit stores a relationship table recording relations between functions and particular human motions. The processing unit is used to determine the function corresponding to the particular human motion determined by the recognition unit, and executes the function.

### BACKGROUND

1. Technical Field

The present disclosure relates to electronic devices and, particularly, to an electronic device capable of detecting user motion and executing a function corresponding to the user motion detected.

2. Description of Related Art

Nowadays, electronic devices, such as TV sets and air conditioners are very popular. Usually, the TV sets and the air conditioners are controlled by a remote controller, and if the remote controller is lost, controlling the device becomes very inconvenient if not impossible.

Therefore, it is desirable to provide an electronic device which overcomes the aforementioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device capable of detecting human motion, in accordance with an exemplary embodiment.

FIG. 2 is a schematic diagram showing a human image being captured by the electronic device of FIG. 1.

FIG. 3 is a flowchart illustrating a method for detecting human motion applied in an electronic device, such as that of FIG. 1, in accordance with an exemplary embodiment.

### DETAILED DESCRIPTION

An embodiment of the present disclosure will now be described in detail, with reference to the accompanying drawings.

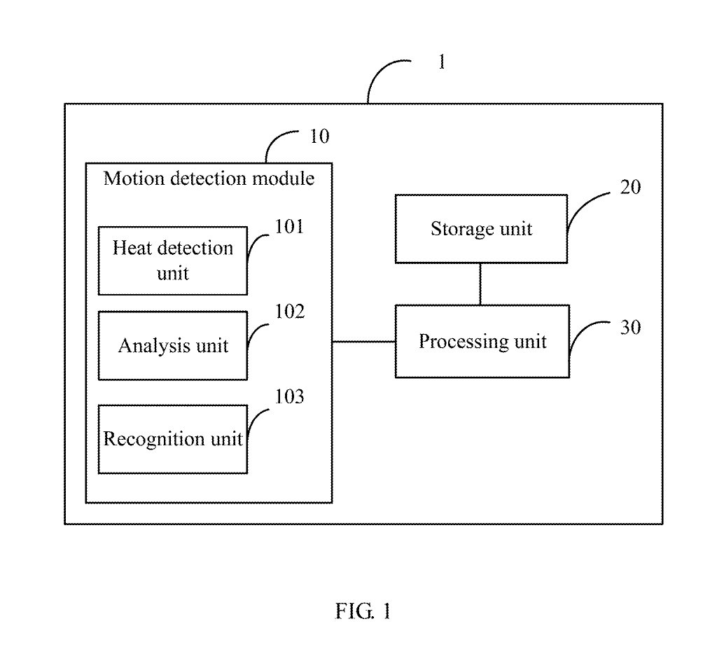

Referring to FIG. 1, an electronic device 1 capable of detecting human motion and executing a function which corresponds with a particular human motion or a type of motion is provided. The electronic device 1 includes a motion detection module 10, a storage unit 20, and a processing unit 30. The motion detection module 10 is used to detect human motions. The storage unit 20 stores a relationship table recording relationships between different particular human motions and particular functions. The processing unit 30 determines the function corresponding to the particular human motion detected by the motion detection module 10 according to the relationship table, and executes the determined function.

The motion detection module 10 includes a heat detection unit 101, an analysis unit 102, and a recognition unit 103. The heat detection unit 101 is used to detect presence of one or more humans around the electronic device 1 within a predetermined area (e.g., 2 meters in radius), and to produce a series of detection signals when the human presence is detected. In the embodiment, the heat detection unit 101 is an infrared detector or other heat detector capable of detecting the heat emitted by a human body. Each detection signal is a grayscale image (a grayscale or black-and-white or monochrome image is composed exclusively of shades of gray, from black to represent the darkest color to white representing the lightest color). The analysis unit 102 receives the grayscale images produced by the heat detection unit 101, and converts the grayscale images into a series of corresponding binary images using the method of Nobuyuki Otsu or a similar method. The recognition unit 103 compares the binary images and determines the changes between these binary images, and so determines the particular human motion. In the embodiment, if the recognition unit 103 determines a lack of significant movement from one binary image to the next over a predetermined time (e.g. 10 seconds), the recognition unit 103 determines that that particular human motion has been completed.

When a particular human motion has been determined, the processing unit 30 determines the function corresponding to the particular human motion determined by the recognition unit 103 according to the relationship table stored in the storage unit 20, and executes the corresponding function. The relationship between different particular human motions and corresponding functions recorded in the relationship table can be set and reset according to the type of the electronic device 1. For example, if the electronic device 1 is a TV set, the functions recorded in the relationship table are suitable for controlling a TV set, such as changing channels, increasing the volume, and so on. If the electronic device 1 is an air conditioner, the functions recorded in the relationship table are suitable for controlling the air conditioner, such as increasing the fan speed, lowering the required temperature, and so on.

In the embodiment, the processing unit 30 allows user input to set or reset the relationships between particular human motions and particular functions, the predetermined area viewed, and any predetermined times.

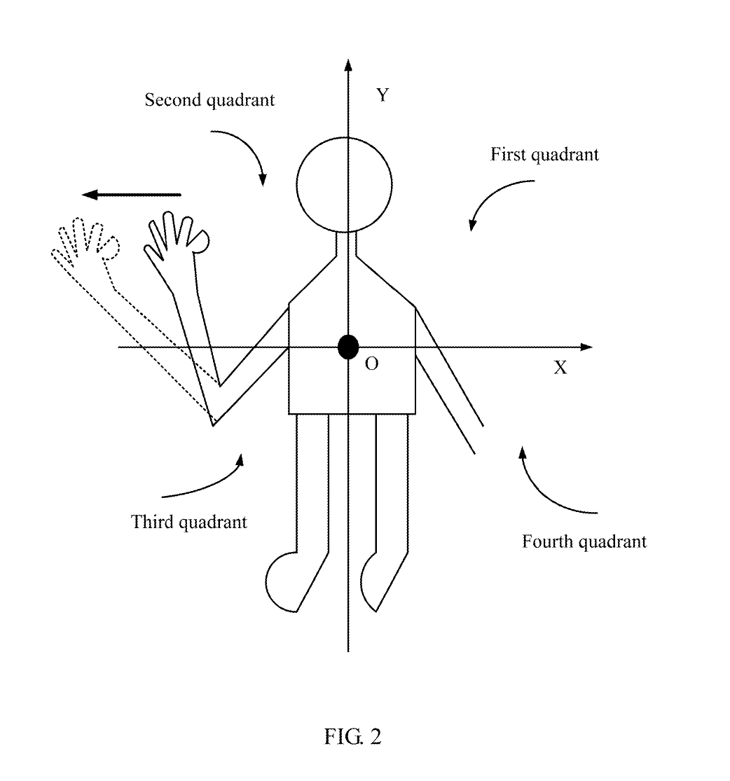

Referring to FIG. 2, in one embodiment, the grayscale images detected by the heat detection unit 101 are images of the whole human body, and the binary images converted by the analysis unit 102 include all such data. When the recognition unit 103 receives a binary image from the analysis unit 102, the recognition unit 103 first determines the center of the image, and this first determination is made in relation to all binary images received. In the embodiment, the center of the binary image is the geometric center O, as shown in FIG. 2. In the embodiment, each pixel in a binary image carries its own coordinates according to a coordinate system with the origin at O as base coordinates, and the recognition unit 103 is able to determine the center of each binary image by utilizing data concerning the pixel coordinates within each binary image. In the embodiment, the geometric center of every binary image is established in the same way.

The recognition unit 103 defines the center of each binary image to produce the base coordinates, and generates a rectangular coordinate system built on the base coordinates. The x-axis and y-axis of the rectangular coordinate system divides each binary image into four parts, a first quadrant, a second quadrant, a third quadrant, and a fourth quadrant. The recognition unit 103 compares each binary image and determines the quadrant in which human movement if any has taken place, and further tracks the movement according to changes in the binary images, the particular human motion can then be determined from the data relevant to these two characteristics or priorities.

In detail, the relative position of each pixel to the next pixel in any binary image and thus any change between these binary images in pixel positions is recognized by the rectangular coordinate system utilized by the recognition unit 103, which can also map pixel coordinates and changes therein in relation to the four quadrants.

For example, as shown in FIG. 2, a human right hand moving from left to right will be recognised as a movement of the right hand by the recognition unit 103 which will further determine that the hand movement is from left to right, and that the right hand is in the second quadrant. The processing unit 30 then executes the function corresponding to that particular human motion according to the relationship table. In the embodiment, if the left hand of the user moves from left to right and that movement is in the first quadrant, the recognition unit 103 can determine a human movement as a left hand moving from left to right, in the first quadrant. If the movements take place in different quadrants, the particular human motion determined by the recognition unit 103 will be different even though it is in fact the same movement.

In the embodiment, the heat detection unit 101 can detect a number of users, and effectively isolate and convey images of each user. In detail, the heat detection unit 101 produces a series of grayscale images including the number of users, the analysis unit 102 converts the grayscale images into a series of corresponding binary images using the method of Nobuyuki Otsu or a similar method. The recognition unit 103 can recognize the motion of each user and the processing unit 30 has the potential to execute each and every function corresponding to all the motions recorded. In detail, the recognition unit 103 compares the binary images and determines each user of these binary images, and respectively determines changes of each user by comparing the changes between these binary images, and so determines the particular human motion of corresponding user. In the embodiment, if the recognition unit 103 determines at least two simultaneous motions, the processing unit 30 executes the function corresponding to the motion first recognised by the recognition unit 103.

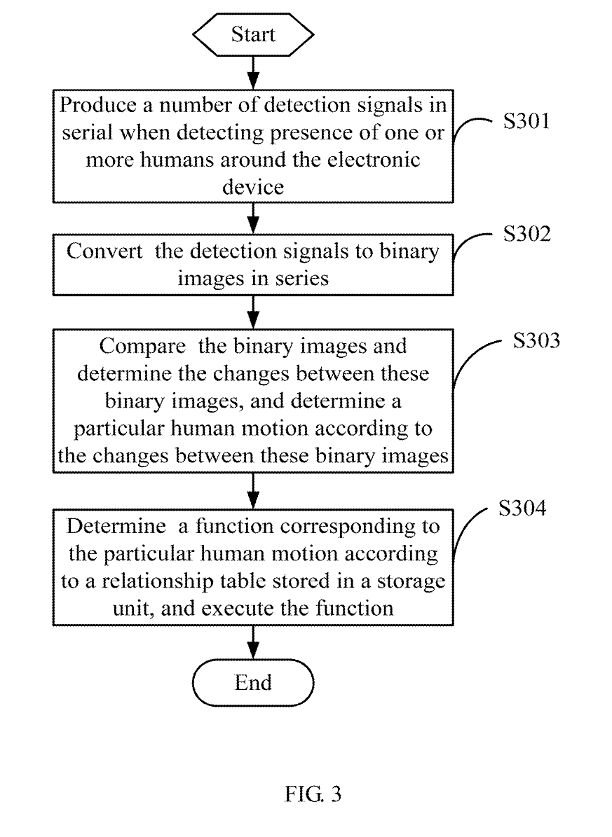

FIG. 3 shows a method for detecting human motion applied in an electronic device, such as that of FIG. 1. In step S301, the heat detection unit 101 detects the presence of one or more humans around the electronic device 1 within a predetermined area (e.g. 2 meters), and produces a series of detection signals accordingly as grayscale images.

In step S302, the analysis unit 102 converts the grayscale images into a corresponding series of binary images.

In step S303, the recognition unit 103 compares each binary image with the next and determines any change in the binary images, and then determines the particular human motion according to the changes. In the embodiment, the recognition unit 103 determines the center of each binary image, and establishes the center of each binary image as the base coordinates, and creates a rectangular coordinate system built on the base coordinates. The rectangular coordinate system applies an x-axis and a y-axis to divide each binary image into four parts, a first quadrant, a second quadrant, a third quadrant, and a fourth quadrant. The recognition unit 103 compares each binary image and determines the part of the human body which is moving and how it is moving, and further determines the quadrant in which the movement is taking place.

The processing unit 30 determines the function corresponding to the particular human motion according to the relationship table stored in the storage unit 20, and executes the function.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A motion detection module for an electronic device, comprising:
a heat detection unit, configured to produce a plurality of detection signals in series when detecting presence of one or more humans around the electronic device within a predetermined area;
an analysis unit, configured to convert the detection signals into binary images in series; and
a recognition unit, configured to compare the binary images and determine the changes between these binary images, and determine a particular human motion according to the changes between these binary images.

2. The motion detection module according to claim 1, wherein the recognition unit further defines a center of each binary image to produce base coordinates, and generates a rectangular coordinate system built on the base coordinates, wherein an x-axis and a y-axis of the rectangular coordinate system divide each binary image into four parts, a first quadrant, a second quadrant, a third quadrant, and a fourth quadrant; compares the binary images and determines the quadrant in which human movement; tracks the movement according to changes in the binary images; and then determines the particular human motion from the data relevant to the quadrant in which human movement if any has taken place and the tracked stages of the movement.

3. The motion detection module according to claim 1, wherein the heat detection unit is an infrared detector, and the detection signals produced by the infrared detector are grayscale images.

4. The motion detection module according to claim 3, wherein the analysis unit converts the grayscale images into binary images.

5. The motion detection module according to claim 1, wherein the analysis unit converts the detection signals into binary images in series by using a Nobuyuki Otsu method.

6. An electronic device comprising:
a motion detection module, comprising:
a heat detection unit, configured to produce a plurality of detection signals in series when detecting presence of one or more humans around the electronic device within a predetermined area;
an analysis unit, configured to convert the detection signals into binary images in series; and
a recognition unit, configured to compare the binary images and determine the changes between these binary images, and determine a particular human motion according to the changes between these binary images;
a storage unit storing a relationship table recording relations between functions and particular human motions; and
a processing unit, configured to determine a function corresponding to the particular human motion determined by the recognition unit, and execute the function.

7. The electronic device according to claim 6, wherein the recognition unit further defines a center of each binary image to produce base coordinates, and generates a rectangular coordinate system built on the base coordinates, wherein an x-axis and a y-axis of the rectangular coordinate system divide each binary image into four parts, a first quadrant, a second quadrant, a third quadrant, and a fourth quadrant; compares the binary images and determines the quadrant in which human movement; tracks the movement according to changes in the binary images; and then determines the particular human motion from the data relevant to the quadrant in which human movement if any has taken place and the tracked stages of the movement.

8. The electronic device according to claim 6, wherein the heat detection unit is an infrared detector, and the detection signals produced by the infrared detector are grayscale images.

9. The electronic device according to claim 8, wherein the analysis unit converts the grayscale images into binary images.

10. The electronic device according to claim 6, wherein the analysis unit converts the detection signals into binary images in series by using a Nobuyuki Otsu method.

11. The electronic device according to claim 6, the processing unit is further configured to set the predetermined area and the relationship table in response to user operation.

12. The electronic device according to claim 6, wherein the electronic device is one selected from the group consisting of a TV set, an air conditioner, and a personal computer.

13. A method for detecting human motions, applied in an electronic device, the electronic device comprising:
a motion detection module comprising a heat detection unit, an analysis unit, and a recognition unit,
a storage unit storing a relationship table recording relations between functions and human motions; and
a processing unit;
the method comprising:
producing a plurality of detection signals in series when detects someone around the electronic device via the heat detection unit, the detection signals are grayscale images;
converting the grayscale images into binary images in series via the analysis unit;
comparing the binary images and determining the changes between these binary images, and determining a particular human motion according to the changes between these binary images via the recognition unit;
determining a function corresponding to the particular human motion according to the relationship table via the processing unit; and
executing the function via the processing unit.

14. The method according to claim 13, wherein the step “comparing the binary images and determining the changes of these binary images, and determining a particular human motion according to the changes of these binary images via the recognition unit” comprises:
defining a center of each binary image to produce base coordinates;
generating a rectangular coordinate system built on the base coordinates;
comparing each binary image and determining the quadrant in which human movement, and further tracking the movement according to changes in the binary images;
determining the particular human motion according to the quadrant in which human movement, and the tracked movement.
